(19) United States
(12) Patent Application Publication
(10) Pub. No.: US 2023/0019927 A1
(43) Pub. Date: Jan. 19, 2023

(54) RADAR APPARATUS, MANUFACTURING METHOD OF RADAR APPARATUS, AND TRANSMITTER/RECEIVER

(71) Applicant: SONY SEMICONDUCTOR SOLUTIONS CORPORATION, KANAGAWA (JP)

(72) Inventor: YUDAI TAKAHASHI, KANAGAWA (JP)

(21) Appl. No.: 17/756,168

(22) PCT Filed: Nov. 10, 2020
(86) PCT No.: PCT/JP2020/041978

§ 371 Date: May 18, 2022

(30) Foreign Application Priority Data
Nov. 27, 2019 (JP) 2019-214551

(51) Int. Cl. H01Q 21/06; H04B 1/72; G01S 13/931; G01S 7/03; H01Q 1/32

(52) U.S. Cl. CPC H01Q 21/068; H04B 1/72; G01S 13/931; G01S 7/03; H01Q 1/32

(57) ABSTRACT

[Object]

To improve accuracy of transmission and reception in antennas.

[Solving Means]

A radar apparatus includes multiple antennas, a power feeding circuit, and dummy antennas. The multiple antennas have a predetermined length in a first direction and are arranged in an array form in a second direction that intersects the first direction. The power feeding circuit is connected to the multiple antennas. The dummy antennas have a length different from the predetermined length and are arranged so as to sandwich the multiple antennas in the second direction.

### TECHNICAL FIELD

The present disclosure relates to a radar apparatus, a manufacturing method of a radar apparatus, and a transmitter/receiver.

### BACKGROUND ART

It is widely common to arrange multiple antennas in parallel to each other to enhance strength, directionality, and other factors of radio wave transmission and reception by the antennas. In order to further enhance accuracy, the antennas are arranged at intervals of λ/2, a virtual MIMO (Multiple-Input and Multiple-Output) technique is used, or an antenna mounting area is reduced by downsizing. As a result, it is necessary to arrange the multiple antennas in proximity to each other. After such an arrangement, it is difficult to reduce an impact of mutual coupling between the antennas, and there is a case where a dummy antenna for controlling radiation patterns of the multiple antennas is further arranged to solve this problem.

### CITATION LIST

### Patent Literature

[PTL1]

Japanese Patent Laid-Open No. 2008-304417

### SUMMARY

### Technical Problem

Although it is possible to create a pseudo environment from the viewpoint of mutual coupling, it is difficult in a high frequency band such as a millimeter wave band to install a terminator with a value of 50Ω or the like that matches other antennas and the like connected to a chip, for example.

Therefore, the present disclosure provides a radar apparatus that improves the transmission and reception accuracy in an antenna by properly setting conditions of an end portion of a dummy antenna.

### Solution to Problem

According to one embodiment, a radar apparatus includes multiple antennas, a power feeding circuit, and dummy antennas. The multiple antennas have a predetermined length in a first direction and are arranged in an array form in a second direction that intersects the first direction. The power feeding circuit is connected to the multiple antennas. The dummy antennas have a length different from the predetermined length and are arranged so as to sandwich the multiple antennas in the second direction.

The dummy antennas may be left open without being connected to the power feeding circuit. The radar apparatus may include the dummy antennas that have ends not connected to the power feeding circuit and that have no terminator (that are open).

The dummy antennas may have the same shape as the multiple antennas in regions other than regions corresponding to portions of the multiple antennas that are connected with the power feeding circuit, and may have a length in the first direction that is different from the length of the multiple antennas, in the regions corresponding to the portions of the multiple antennas that are connected with the power feeding circuit. In such a manner, the length of end portions of the dummy antennas may be different from that of the antennas.

The length of the dummy antennas may be shorter than the predetermined length. Also, the length of the dummy antennas may be longer than the predetermined length. The length of the dummy antennas need only be different from the predetermined length and may be longer or shorter than that of the antennas.

A difference between the length of the dummy antennas and the predetermined length may be a half wavelength of a radio wave to be transmitted and received or more but less than a full wavelength. Also, a difference between the length of the dummy antennas and the predetermined length may be a quarter wavelength of the radio wave to be transmitted and received or more but less than the half wavelength. In addition, a difference between the length of the dummy antennas and the predetermined length may be a one-eighth wavelength of the radio wave to be transmitted and received or more but less than the quarter wavelength. Further, a difference between the length of the dummy antennas and the predetermined length may be less than the one-eighth wavelength of the radio wave to be transmitted and received.

The multiple antennas may be arranged such that adjacent ones of the antennas are spaced from each other in the second direction at a distance of the half wavelength of the radio wave to be transmitted and received. In such a manner, the adjacent ones of the antennas may be arranged so as to be spaced from each other at a distance of λ/2.

The multiple antennas may be arranged such that adjacent ones of the antennas are spaced from each other in the first direction at a distance of the half wavelength of the radio wave to be transmitted and received. In such a manner, the adjacent ones of the antennas may be arranged so as to be shifted by a distance of λ/2 in a length direction.

In a case where the number of the multiple antennas is n, where an antenna arranged on any one of sides is assumed to be a first antenna, and where an antenna arranged on another side is assumed to be an n-th antenna, an i-th antenna (1≤i≤n) may be arranged at a distance of the half wavelength of the radio wave to be transmitted and received×i, in the first direction with respect to the first antenna. In such a manner, the adjacent ones of the antennas may be arranged in the form of a staircase so as to be shifted in the first direction.

The multiple dummy antennas may be arranged at multiple positions in the first direction that include at least a position at a distance of the half wavelength of the radio wave to be transmitted and received×(−1), from the i-th antenna, and a position at a distance of the half wavelength of the radio wave to be transmitted and received, from the n-th antenna. For example, at least two dummy antennas may be arranged so as to sandwich the antennas from both sides. In a case where the antennas are arranged in the form of a staircase in the first direction as described above, the dummy antennas may also be arranged in line so as to be consistent with the arrangement of the antennas in the form of a staircase.

A manufacturing method of a radar apparatus according to an embodiment may shave dummy antennas to make a length thereof different from a predetermined length. The radar apparatus includes multiple antennas, a power feeding circuit, and the dummy antennas. The multiple antennas have the predetermined length in a first direction and are arranged in an array form in a second direction that intersects the first direction. The power feeding circuit is connected to the multiple antennas. The dummy antennas are arranged so as to sandwich the multiple antennas in the second direction. In such a manner, an antenna section of the radar apparatus may be manufactured by shaving the dummy antennas.

The length of the dummy antennas may be adjusted every predetermined unit length. The predetermined length may be a full wavelength, a half wavelength, a quarter wavelength, or a one-eighth wavelength of a radio wave to be transmitted and received by the multiple antennas. The adjustment in such a manner makes it possible to manufacture the above radar apparatus.

A transmitter/receiver according to an embodiment may include multiple antennas, a power feeding circuit, and dummy antennas. The multiple antennas have a predetermined length. The power feeding circuit is connected to the multiple antennas. The dummy antennas have a length different from the predetermined length. Each of the above embodiments may be used for, instead of the radar apparatus, other transmitter/receiver such as a radio wave transmitter/receiver.

### BRIEF DESCRIPTION OF DRAWINGS

FIG. 1 is a diagram schematically illustrating a radar apparatus according to an embodiment.

FIG. 2 is a diagram schematically illustrating the radar apparatus according to an embodiment.

FIG. 3 is a diagram schematically illustrating the radar apparatus according to an embodiment.

FIG. 4 is a diagram schematically illustrating the radar apparatus according to an embodiment.

FIG. 5 is a diagram schematically illustrating the radar apparatus according to an embodiment.

FIG. 6 is a block diagram depicting an example of schematic configuration of a vehicle control system.

FIG. 7 is a diagram of assistance in explaining an example of installation positions of an outside-vehicle information detecting section and an imaging section.

### DESCRIPTION OF EMBODIMENTS

A description will be given below regarding embodiments of the present disclosure with reference to drawings. The drawings are used for the purpose of description, and the shape or size of each component in an actual apparatus, the size ratio of the component to another component, or the like need not be as illustrated in the drawings. Further, the drawings are drawn in a simplified manner, and it is assumed that, in addition to the components illustrated in the drawings, components required for implementation are provided properly. Moreover, even in a case where components are described to have the same shape, the same size, the same length, and the like in the present specification, these components may not necessarily have exactly the same shape, the same size, the same length, and the like, and the expressions herein may include an individual difference which is not significant, for example.

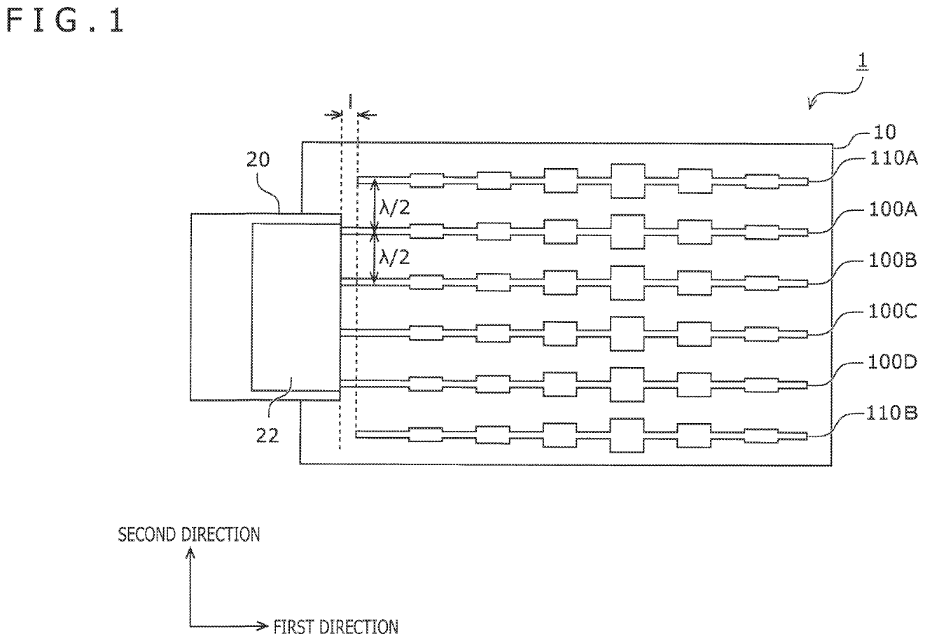

FIG. 1 is a diagram schematically illustrating a radar apparatus according to an embodiment. A radar apparatus 1 includes an antenna chip 10 (or an antenna substrate) and a power supply chip 20 (or a power feeding chip). It should be noted that, although these components are illustrated as being separate for reasons of convenience, antennas and a power supply may be provided on the same chip. The radar apparatus 1 measures, for example, a distance to a target by transmitting and receiving a radio wave in a millimeter wave band.

The antenna chip 10 includes antennas 100 and dummy antennas 110. In FIG. 1, for example, four antennas, that is, antennas 100A, 100B, 100C, and 100D, that extend longitudinally along a first direction and dummy antennas 110A and 110B having the same shape and size as the four antennas are arranged. The multiple antennas 100 and the dummy antennas 110 that are disposed so as to sandwich the multiple antennas 100 are arranged in an array form, for example, in a second direction that intersects the first direction. It should be noted that, although the four antennas 100 are arranged, these antennas are illustrated as an example, and the number of antennas 100 is not limited to four. Less than four antennas or more than four antennas may be arranged.

The multiple antennas 100 have, for example, the same shape and size. The longitudinal size of the antennas 100 that extend in the first direction will be defined as a length. That is, the multiple antennas 100 have at least a predetermined length.

The multiple antennas 100 are spaced from one another at a distance of a half wavelength λ/2 or more of the radio wave to be transmitted and received therebetween. With the antennas spaced from one another at a distance of λ/2 or more, it is possible to suppress radio wave grating lobes in a visible range and improve directivity with high accuracy. In FIG. 1, for example, the antennas 100 are spaced from one another at a distance of λ/2. It should be noted here that a wavelength of the radio wave may be a wavelength of a radio wave in a case where it is transmitted in air or a wavelength of a radio wave in a case where it comes under the influence of a dielectric in the antenna chip 10. Here, it is assumed, for example, that the wavelength of the radio wave is a wavelength of a radio wave in the dielectric.

The dummy antennas 110 have, for example, the same shape as the antennas 100 and are arranged so as to sandwich the multiple antennas 100 from both sides. In FIG. 1, for example, two dummy antennas, that is, the dummy antennas 110A and 110B, which have the same shape and size as the antennas 100 are arranged so as to sandwich the array of the antennas 100 from both sides.

Each of the dummy antennas 110 is spaced from the adjacent antenna 100 at a distance of λ/2 or more. This distance between the dummy antenna 110 and the antenna 100 is provided in order to suppress, for example, disturbance of the directivity of the antennas 100 caused by the radio waves reflected by the dummy antennas 110, similarly to the case described above. For example, the disturbance of the directivity is caused by the interference between the radio wave reflected by the dummy antenna 110 and the radio wave radiated by the antenna 100.

While the dummy antennas 110 have the same shape and size as the antennas 100, a length of the dummy antennas 110 in the first direction is different from that of the antennas 100. In FIG. 1, for example, the dummy antennas 110 are shorter than the predetermined length.

The power supply chip 20 supplies the antenna chip 10 with power for transmitting the radio waves from the antennas. Further, the power supply chip 20 receives, from the antennas, signals based on the radio waves received by the antennas. The power supply chip 20 includes a power feeding circuit 22.

The power feeding circuit 22 is a circuit that is electrically connected to the multiple antennas 100 and that supplies power to the antennas 100 or receives power from the antennas. Each of the antennas 100 has an end portion connected to the power feeding circuit 22 and sends the radio wave on the basis of power (signal) supplied from the power feeding circuit 22. Also, the power feeding circuit 22 may receive, from the antennas 100, the radio waves that have been converted into a current, a voltage, or the like by the antennas 100 and received by the antennas 100. On the other hand, the dummy antennas 110 are left open without being connected to the power feeding circuit 22 or other circuitry.

Although it is preferred that the dummy antennas 110 have, for example, terminators of 50Ω similar to a value at a connection between the antennas 100 and the power feeding circuit, it is difficult to arrange the 50Ω terminator in the millimeter wave band. According to the present embodiment, the length of the end portions of the dummy antennas 110 is made different from that of the antennas 100. Thus, while the radio wave interference between the radio waves reflected inside the dummy antennas and the radio waves in the antennas 100 is suppressed, mutual coupling between the dummy antennas 110 and the antennas 100 is generated similarly to the mutual coupling between the antennas 100.

As described above, according to the present embodiment, by adjusting the length of the end portions of the dummy antennas, it is possible to control the reflection of the radio waves inside the dummy antennas and achieve the mutual coupling between the antennas and the dummy antennas in a similar manner to the mutual coupling between the antennas. As a result, a transmitter/receiver having the multiple antennas arranged in an array form can have such a structure as to even out the conditions of the radio wave transmission and reception performed by the antennas provided on both sides and the radio wave transmission and reception performed by the antennas provided therebetween, and to suppress the occurrence of the grating lobe or the like caused by the radio waves reflected by the dummy antennas. Consequently, it becomes possible to reduce the difference in the pattern of the radio wave transmitted and received by each of the antennas 100.

A description will be given below regarding an example of arrangement and the like of the antennas 100 and the dummy antennas 110.

As described above in FIG. 1, the dummy antennas 110 may be arranged in an array form along the first direction in such a manner that the dummy antennas 110 look as if they are integral with the multiple antennas 100. In this case, the dummy antennas 110 are formed and arranged, for example, such that the length of the end portions thereof is smaller by a length l than that of the antennas 100.

The length l may be, for example, shorter than a wavelength λ of the radio wave to be transmitted and received. The reason for this is that, in a case where the reflection of the radio wave at the end portions of the dummy antennas 110 is considered, even if the length is changed in a range greater than the full wavelength, no significant change occurs theoretically as compared to a case where the length is changed within the full wavelength.

For example, l may be adjusted in steps of λ/8. For example, l may be any one of λ/8, λ/4, 3λ/8, λ/2, 5λ/8, 3λ/4, and 7λ/8. Also, for example, l may be adjusted in steps of λ/4 and be any one of λ/4, λ/2, 3λ/4, and λ. The length of the multiple dummy antennas 110 may be different from that of the antennas 100 by the same length. Alternatively, the length of each of the dummy antennas 110 may be different from that of the antennas 100 by a different length.

This length adjustment may vary depending on the shape, arrangement, and the like of the antennas. For example, in a case where the shape of the antennas 100 is different from that illustrated in FIG. 1, the value of l may be adjusted to a different value. In such a manner, the length l may be changed on the basis of the shape, size, and the like of the antennas 100 that are arranged in practice.

In a case where the dummy antennas 110 are shorter than the antennas 100 as illustrated in FIG. 1, the length of the dummy antennas 110 may be adjusted by forming the dummy antennas 110 in the same shape and size as the antennas 100 at the time of the formation of the antennas 100 and then shaving the end portions of the dummy antennas 110 after the formation of the dummy antennas 110. At the time of the shaving, for example, the dummy antennas 110 may be adjusted to an optimal length by measuring the transmitted and received radio waves while shaving the dummy antennas 110 by λ/8 at a time. For example, the dummy antenna 110 is formed with the predetermined length and is then shaved by λ/8 at a time, and an optimal length is extracted from among the lengths reduced by up to λ. The length may be adjusted by further shaving the dummy antennas 110 by this extracted length.

Also, in a case where a product of the same model is manufactured, the length may be adjusted as follows. Specifically, the dummy antenna 110 is shaved by up to λ to acquire the optimal length as described above, and the dummy antennas 110 are shaved on the basis of the acquired length in the manufacture of the product of the same model.

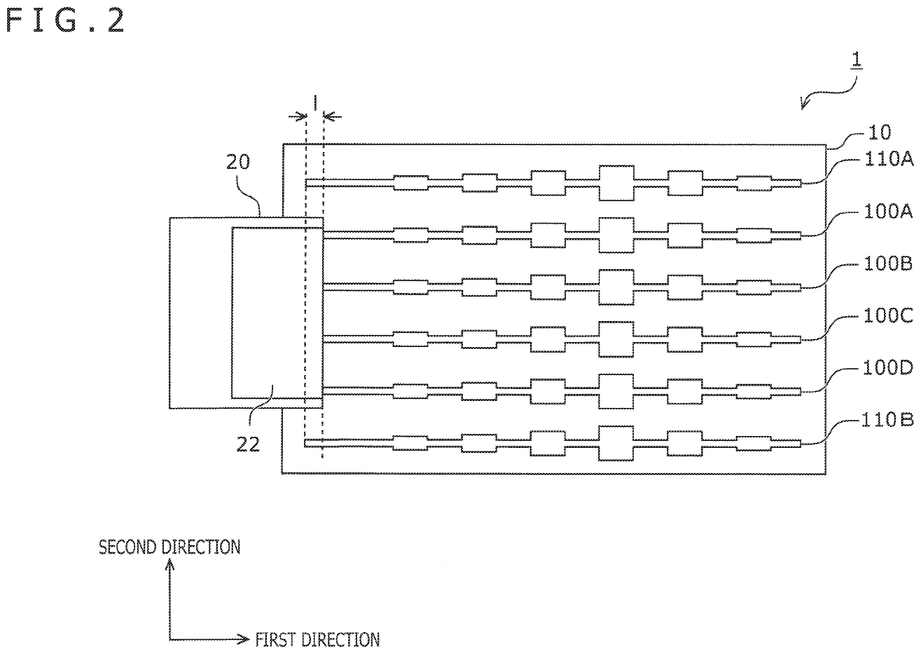

FIG. 2 is a diagram schematically illustrating another example of the dummy antennas 110. The end portions of the dummy antennas 110 may be longer than those of the antennas 100 by the length l. Similarly in this case, it is possible to optimize the reflection of the radio waves by the dummy antennas.

For example, the optimal length l may be acquired by forming, at the time of the formation of the antennas 100, the dummy antennas 110 with a longer length than the predetermined length of the antennas 100 by λ and shaving the dummy antennas 110 by λ/8 at a time as described above. The adjustment of the length is not limited thereto, and the length may be adjusted by forming the dummy antennas 110 with a sufficiently longer length than the predetermined length of the antennas 100 by more than λ and shaving the dummy antennas 110.

It should be noted that, in FIGS. 1 and 2 and subsequent figures, the length may not necessarily be adjusted in steps of λ/8 and may be adjusted in finer steps such as λ/16 or λ/32. Further, although an example in which the radio waves are transmitted and received while the dummy antennas are shaved has been described, the present embodiment is not limited thereto. The length of the dummy antennas may be changed and adjusted virtually by means of a simulator or the like, and thereafter, the adjusted length may be applied to an actual apparatus.

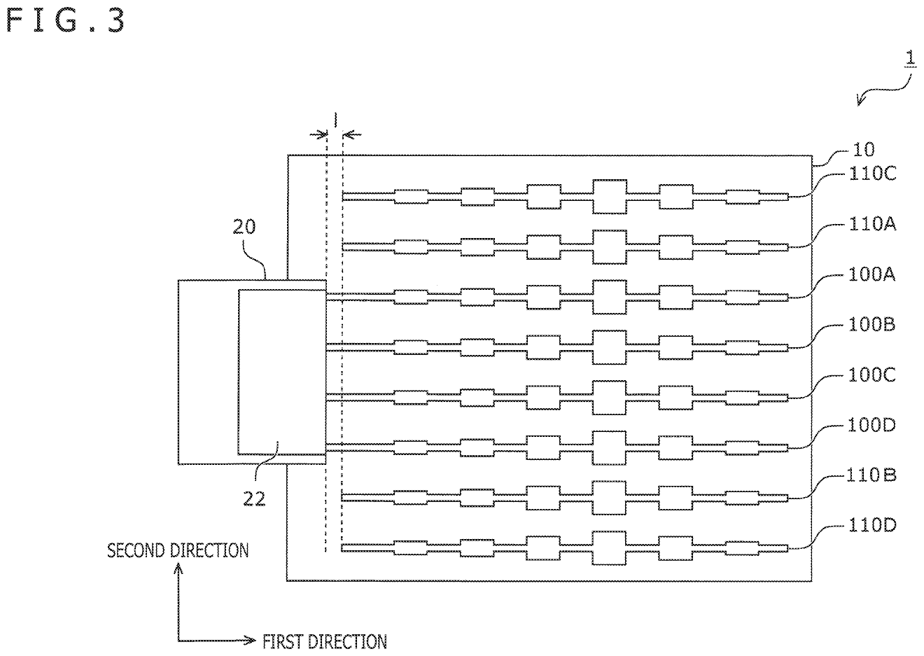

FIG. 3 is a diagram illustrating another example of the arrangement of the dummy antennas 110. The multiple dummy antennas 110 may be arranged on each side so as to sandwich the antenna array. In FIG. 3, in addition to the dummy antennas 110A and 110B, dummy antennas 110C and 110D are further provided on the outside of the dummy antennas 110A and 110B, respectively. In such a manner, the four or more dummy antennas 110 may be provided.

With the multiple dummy antennas 110 provided on each side in such a manner, it is possible to further even out the conditions of the radio wave transmission and reception performed by the respective antennas 100. In FIG. 1, for example, the antennas 100A and 100D are similarly affected by the dummy antennas 110, the antenna 100B, and the antenna 100C. Accordingly, while it is possible to transmit and receive the radio waves that have been similarly corrected for mutual coupling, characteristics of the antennas 100A and 100D become different from those of the antennas 100B and 100C.

The provision of the multiple dummy antennas 110 on each side improves accuracy for correcting an impact of mutual coupling between the antennas 100 by means of the dummy antennas 110 and makes it possible to correct the forming of the radio waves to be transmitted and received, with higher accuracy. It should be noted that, although four dummy antennas 110 are provided in total in FIG. 3, that is, two dummy antennas 110 are provided on each side, the number of dummy antennas 110 is not limited thereto, and more than four dummy antennas 110 may be provided. For example, the dummy antennas 110 in number equal to half the number of antennas 100 or more than half the number of antennas 100 may be provided on one side to sufficiently deal with mutual coupling between the antennas 100.

In a case where two or more dummy antennas 110 are provided, all the dummy antennas 110 may be set to the same length. The length of the dummy antennas 110 is not limited thereto, and the dummy antennas 110 may be adjusted to different lengths. In a case where the dummy antennas 110 are adjusted to different lengths, the dummy antennas 110A and 110B may be set to the same length, and the dummy antennas 110C and 110D may be set to the same length, for example, in FIG. 3.

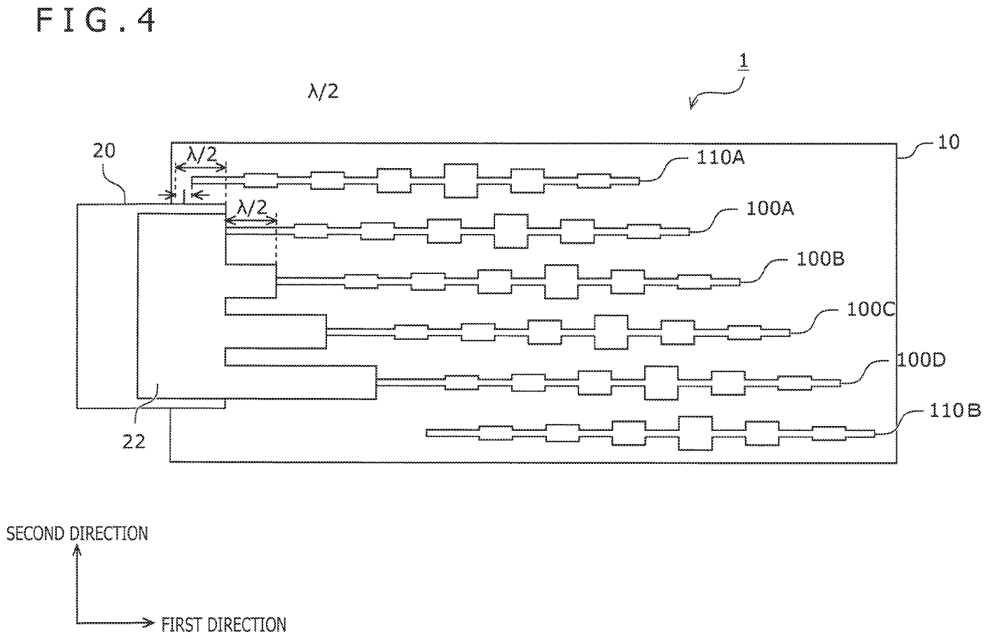

FIG. 4 is a diagram illustrating another example of the arrangement of the dummy antennas 110. The multiple antennas 100 are arranged out of alignment from each other along the first direction. Even in such a case, it is possible to arrange the dummy antennas 110 by means similar to the above. As illustrated in FIG. 4, for example, the respective antennas 100 may be arranged in the form of a staircase where steps are shifted by a distance of λ/2 along the first direction away from the power feeding circuit 22.

The dummy antennas 110 are spaced from both sides at a distance of λ/2 and arranged in the form of a staircase together with the antennas 100 in the first direction. Further, the end portions of the dummy antennas 110 are shorter or longer than those of the antennas 100 by the length l. In such a manner as described above, even in a case where the arrangement of the antennas 100 is different, it is similarly possible to arrange the dummy antennas 110 having a length different from the predetermined length.

The dummy antennas 110 are arranged so as not to be inconsistent with the arrangement of the antenna array. Further, the dummy antennas 110 are formed so as to have a different length from the length of the antennas 100 by adjusting the end portions of the dummy antennas 110. In such a manner, even in a case where the antennas 100 are not arranged in a simple array form, the above embodiment is applicable. In this case, it is also possible to properly optimize the radio waves reflected by the dummy antennas 110, by changing the end lengths of the dummy antennas 110. As a result, it becomes possible to reduce the difference in the pattern of the radio wave transmitted and received by each of the antennas 100.

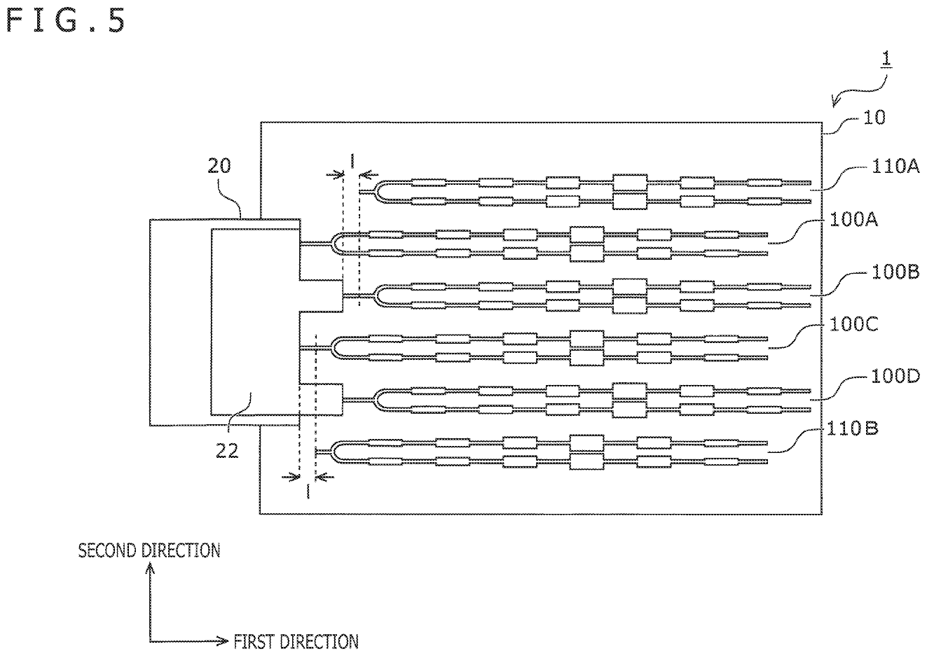

FIG. 5 is a diagram illustrating another example of the arrangement of the dummy antennas 110. The multiple antennas 100 are arranged so as to be alternately shifted by a predetermined distance in the first direction. In such a case, it is also possible to arrange the dummy antennas 110 by means similar to the above. As illustrated in FIG. 5, for example, the respective antennas 100 may be arranged so as to be alternately shifted by a distance of 80 /2 along the first direction away from the power feeding circuit 22 and towards the power feeding circuit 22.

The dummy antennas 110 are arranged so as to be spaced in the first direction from the antennas 100 that are arranged on both sides, at the same intervals as the antennas 100. The distance between the antennas 100 may be, for example, λ/2. The end length of the dummy antennas 110 is shorter than that of the antennas 100 by the length l, similarly to each of the above embodiments.

In FIG. 5, the dummy antennas 110 are also arranged so as not to be inconsistent with the arrangement of the antenna array, and the end lengths thereof are adjusted, similarly to the case illustrated in FIG. 4.

Further, even in a case where an antenna that has an end connected to the power feeding circuit 22 and an opposite end branching into two parts is used as illustrated in FIG. 5, the dummy antennas 110 can similarly be arranged together with the antennas. In this case, the dummy antennas 110 have the same shape and size as the antennas 100 except for their end lengths, similarly to the above embodiments.

As described in the aspects above, it is possible to reduce distortion of the patterns in the multiple antennas 100 by adjusting the end lengths of the dummy antennas 110. This is based on the adjustment of phases of the radio waves reflected by the dummy antennas 110. In each of the above aspects, for example, the length l may be determined by acquiring the approximate length l through simulation in advance and performing more precise testing with an actual machine. It becomes possible to further suppress the distortion of the patterns by arranging the multiple dummy antennas having the end length that provides an ameliorating effect.

It should be noted that, while an example in which the antennas are used in the radar apparatus has been described in the above embodiments, the antennas may be used in not only the radar apparatus but also a common transmitter/receiver such as a radio wave transmitter/receiver and an optical transmitter/receiver. Also, the shape of the antenna is not limited to those illustrated in the drawings, and the antennas may be applied to various antennas that are arranged in a similar array form.

The technology according to the present disclosure is applicable to a variety of products. For example, the technology according to the present disclosure may be realized as an apparatus to be mounted on any one of the types of mobile bodies such as an automobile, an electric vehicle, a hybrid electric vehicle, a motorcycle, a bicycle, a personal mobility, an airplane, a drone, a ship, a robot, a construction machinery, and an agricultural machinery (tractor).

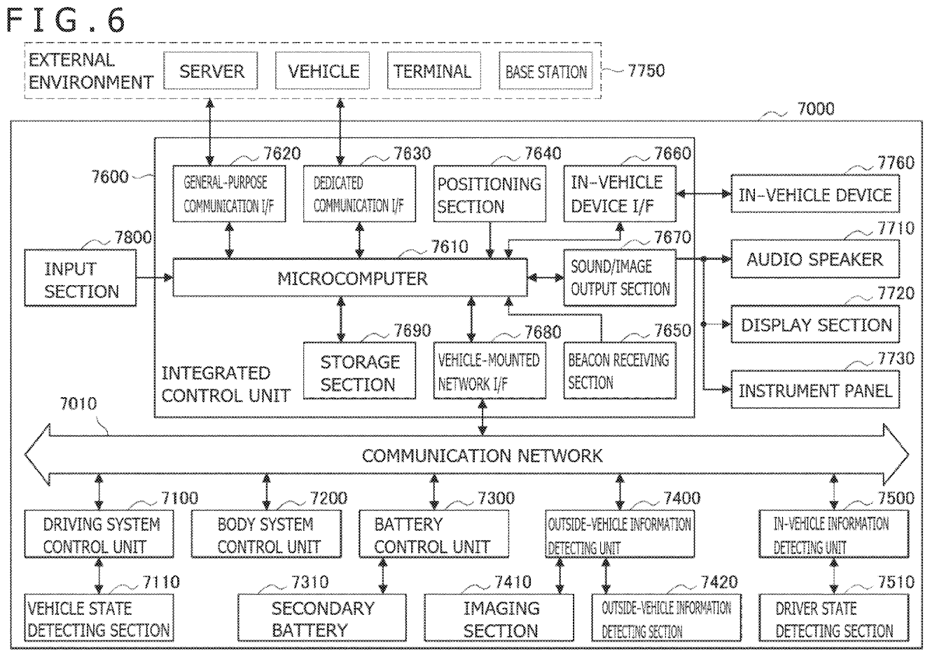

FIG. 6 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 6, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 6 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

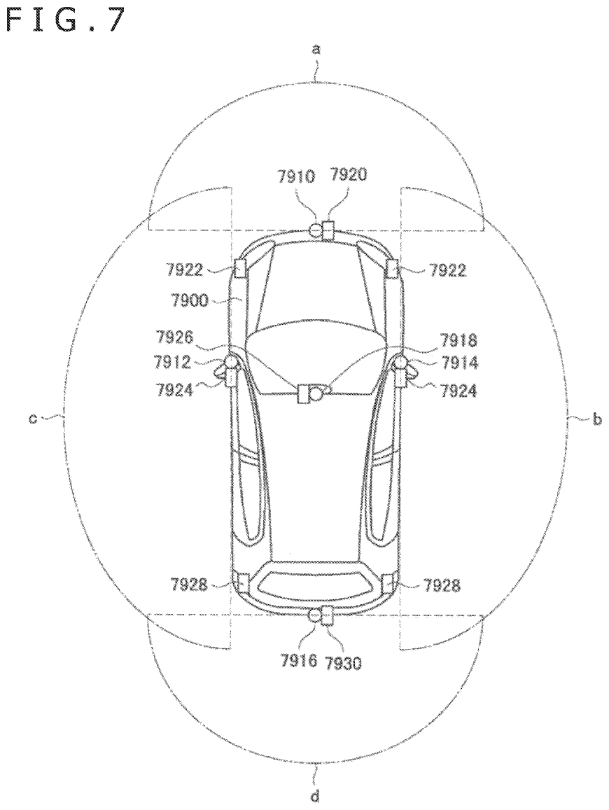

FIG. 7 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 7 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 7, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 6, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 6 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 described above, the radar apparatus 1 according to the present embodiment, which is described by using FIGS. 1 to 5, is applicable to the positioning section 7640 in the application example illustrated in FIG. 6. For example, the positioning section 7640 may include the radar apparatus 1 illustrated in FIGS. 1 to 5, and the microcomputer 7610 of the integrated control unit 7600 or the like may perform the transmission and reception of signals from the power feeding circuit 22. Such implementation allows the radar apparatus 1 according to the present embodiment to be used as a positioning apparatus of the mobile body.

The above embodiments may also have the following configurations.
(1)

A radar apparatus including:

multiple antennas that have a predetermined length in a first direction and that are arranged in an array form in a second direction intersecting the first direction;

a power feeding circuit connected to the multiple antennas; and

dummy antennas that have a length different from the predetermined length and that are arranged so as to sandwich the multiple antennas in the second direction.
(2)

The radar apparatus according to (1), in which

the dummy antennas are left open without being connected to the power feeding circuit.
(3)

The radar apparatus according to (1) or (2), in which

the dummy antennas have
the same shape as the multiple antennas in regions other than regions corresponding to portions of the multiple antennas that are connected with the power feeding circuit, and
a length in the first direction that is different from the length of the multiple antennas, in the regions corresponding to the portions of the multiple antennas that are connected with the power feeding circuit.
(4)

The radar apparatus according to any one of (1) to (3), in which

the length of the dummy antennas is shorter than the predetermined length.
(5)

The radar apparatus according to any one of (1) to (4), in which

the length of the dummy antennas is longer than the predetermined length.
(6)

The radar apparatus according to any one of (1) to (5), in which

a difference between the length of the dummy antennas and the predetermined length is a half wavelength of a radio wave to be transmitted and received or more but less than a full wavelength.
(7)

The radar apparatus according to any one of (1) to (6), in which

a difference between the length of the dummy antennas and the predetermined length is a quarter wavelength of the radio wave to be transmitted and received or more but less than the half wavelength.
(8)

The radar apparatus according to any one of (1) to (7), in which

a difference between the length of the dummy antennas and the predetermined length is a one-eighth wavelength of the radio wave to be transmitted and received or more but less than the quarter wavelength.
(9)

The radar apparatus according to any one of (1) to (8), in which

the multiple antennas are arranged such that adjacent ones of the antennas are spaced from each other in the second direction at a distance of the half wavelength of the radio wave to be transmitted and received.
(10)

The radar apparatus according to any one of (1) to (9), in which

the multiple antennas are arranged such that adjacent ones of the antennas are spaced from each other in the first direction at a distance of the half wavelength of the radio wave to be transmitted and received.
(11)

The radar apparatus according to (10), in which,

in a case where the number of the multiple antennas is n, where an antenna arranged on any one of sides is assumed to be a first antenna, and where an antenna arranged on another side is assumed to be an n-th antenna, an i-th antenna (1≤i≤n) is arranged at a distance of the half wavelength of the radio wave to be transmitted and received×i, in the first direction with respect to the first antenna.
(12)

The radar apparatus according to (11), in which

the multiple dummy antennas are arranged at multiple positions in the first direction that include at least
a position at a distance of the half wavelength of the radio wave to be transmitted and received×(−1), from the i-th antenna, and
a position at a distance of the half wavelength of the radio wave to be transmitted and received, from the n-th antenna.
(13)

A manufacturing method of a radar apparatus,

the radar apparatus including
multiple antennas that have a predetermined length in a first direction and that are arranged in an array form in a second direction intersecting the first direction,
a power feeding circuit connected to the multiple antennas, and
dummy antennas arranged so as to sandwich the multiple antennas in the second direction,

the manufacturing method including:

shaving the dummy antennas to make a length thereof different from the predetermined length.
(14)

The manufacturing method of a radar apparatus according to (13), in which

the length of the dummy antennas is adjusted every predetermined unit length.
(15)

The manufacturing method of a radar apparatus according to (14), in which

the predetermined unit length includes a full wavelength, a half wavelength, a quarter wavelength, or a one-eighth wavelength of a radio wave to be transmitted and received by the multiple antennas.
(16)

A transmitter/receiver including:

multiple antennas having a predetermined length;

a power feeding circuit connected to the multiple antennas; and

dummy antennas having a length different from the predetermined length.

The aspects of the present disclosure are not limited to the above embodiments and include various conceivable modifications, and advantageous effects of the present disclosure are not limited to the above details. The components of the respective embodiments may be combined properly for application. That is, various additions, changes, and partial deletions are possible without departing from a conceptual idea and gist of the present disclosure that are derived from the details defined in the claims and equivalents thereof.

### REFERENCE SIGNS LIST

1: Radar apparatus

10: Antenna chip

100, 100A, 100B, 100C, 100D: Antenna

110, 110A, 110B, 110C, 110D: Dummy antenna

20: Power supply chip

22: Power feeding circuit

1. A radar apparatus comprising:
multiple antennas that have a predetermined length in a first direction and that are arranged in an array form in a second direction intersecting the first direction;
a power feeding circuit connected to the multiple antennas; and
dummy antennas that have a length different from the predetermined length and that are arranged so as to sandwich the multiple antennas in the second direction.

2. The radar apparatus according to claim 1, wherein
the dummy antennas are left open without being connected to the power feeding circuit.

3. The radar apparatus according to claim 1, wherein
the dummy antennas have
a same shape as the multiple antennas in regions other than regions corresponding to portions of the multiple antennas that are connected with the power feeding circuit, and
a length in the first direction that is different from the length of the multiple antennas, in the regions corresponding to the portions of the multiple antennas that are connected with the power feeding circuit.

4. The radar apparatus according to claim 1, wherein
the length of the dummy antennas is shorter than the predetermined length.

5. The radar apparatus according to claim 1, wherein
the length of the dummy antennas is longer than the predetermined length.

6. The radar apparatus according to claim 1, wherein
a difference between the length of the dummy antennas and the predetermined length is a half wavelength of a radio wave to be transmitted and received or more but less than a full wavelength.

7. The radar apparatus according to claim 1, wherein
a difference between the length of the dummy antennas and the predetermined length is a quarter wavelength of the radio wave to be transmitted and received or more but less than the half wavelength.

8. The radar apparatus according to claim 1, wherein
a difference between the length of the dummy antennas and the predetermined length is a one-eighth wavelength of the radio wave to be transmitted and received or more but less than the quarter wavelength.

9. The radar apparatus according to claim 1, wherein
the multiple antennas are arranged such that adjacent ones of the antennas are spaced from each other in the second direction at a distance of the half wavelength of the radio wave to be transmitted and received.

10. The radar apparatus according to claim 1, wherein
the multiple antennas are arranged such that adjacent ones of the antennas are spaced from each other in the first direction at a distance of the half wavelength of the radio wave to be transmitted and received.

11. The radar apparatus according to claim 10, wherein,
in a case where the number of the multiple antennas is n, where an antenna arranged on any one of sides is assumed to be a first antenna, and where an antenna arranged on another side is assumed to be an n-th antenna, an i-th antenna (1≤i≤n) is arranged at a distance of the half wavelength of the radio wave to be transmitted and received×i, in the first direction with respect to the first antenna.

12. The radar apparatus according to claim 11, wherein
the multiple dummy antennas are arranged at multiple positions in the first direction that include at least
a position at a distance of the half wavelength of the radio wave to be transmitted and received×(−1), from the i-th antenna, and
a position at a distance of the half wavelength of the radio wave to be transmitted and received, from the n-th antenna.

13. A manufacturing method of a radar apparatus,
the radar apparatus including
multiple antennas that have a predetermined length in a first direction and that are arranged in an array form in a second direction intersecting the first direction,
a power feeding circuit connected to the multiple antennas, and
dummy antennas arranged so as to sandwich the multiple antennas in the second direction,
the manufacturing method comprising:
shaving the dummy antennas to make a length thereof different from the predetermined length.

14. The manufacturing method of a radar apparatus according to claim 13, wherein
the length of the dummy antennas is adjusted every predetermined unit length.

15. The manufacturing method of a radar apparatus according to claim 14, wherein
the predetermined unit length includes a full wavelength, a half wavelength, a quarter wavelength, or a one-eighth wavelength of a radio wave to be transmitted and received by the multiple antennas.

16. A transmitter/receiver comprising:
multiple antennas having a predetermined length;
a power feeding circuit connected to the multiple antennas; and
dummy antennas having a length different from the predetermined length.
